(19) United States
(12) Patent Application Publication
(10) Pub. No.: US 2005/0012542 A1
(43) Pub. Date: Jan. 20, 2005

(54) Power supply

(75) Inventors: Takahito Kushima, Takatsuki-shi (JP); Kenji Miyake, Kusatsu-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Electric Industrial Co., Ltd., Kadoma-shi (JP)

(21) Appl. No.: 10/891,086

(22) Filed: Jul. 15, 2004

(30) Foreign Application Priority Data
Jul. 15, 2003 (JP) 2003-274384

(51) Int. Cl. G05F 3/02

(52) U.S. Cl. 327/536

(57) ABSTRACT

A first control circuit is connected to a first booster circuit 30 which is a charge pump circuit. A capacitor C1 is shared by a charging operation for generating a first power source, which is a double boosting output of Vin (=V1=V3), from an output terminal Vout1 and a charging operation for generating a second power source, which is a −1-fold boosting output of Vin (=V1), from an output terminal Vout2, to generate the first power source and the second power source. Thereafter, the connection is switched from the first control circuit to a second control circuit, so that the first power source and the third power source, which is a triple boosting output of Vin (=V1=V3=V7) from the output terminal Vout2, are generated.

### FIELD OF THE INVENTION

The present invention relates to a power supply for generating a plurality of power sources through a charging operation and a pumping operation performed by a charge pump circuit.

### BACKGROUND OF THE INVENTION

Conventionally in liquid crystal display devices which feature a small thickness and low power consumption and are widely used as display devices, a high power supply voltage is necessary for achieving preferred display characteristics in the driving of the liquid crystal devices. For this reason, in a power supply used for the liquid crystal display device, input voltage is boosted by a booster circuit and is supplied to a driving circuit and the like for driving a liquid crystal device.

The conventional power supply will be described below.

FIG. 9 is a circuit diagram showing the configuration of the conventional power supply and a double booster circuit for generating a potential of V17+V18 which is the sum of a potential V17 and a potential V18. FIG. 10 is a timing chart showing control signals supplied to the booster circuit of the conventional power supply. A control signal a and a control signal b are adjusted in pulse width so that “H” sections of the signals do not overlap each other. Switching elements S1, S2, S3, and S4 are controlled by these two signals.

When such control signals a and b are supplied to a booster circuit shown in FIG. 9, the switching elements S1 and S2 are first turned on in a section P1 of FIG. 10, whereas the switching elements S3 and S4 are turned off. Thus, a capacitor C8 is connected between a potential V17 and a ground potential (GND) and a charge of V17 is accumulated in the capacitor C8. After a sufficient charge is accumulated in the capacitor C8, the switch Si and the switch S2 are turned off.

Then, in a section P2 of FIG. 10, the switch S3 and the switch S4 are turned on. Thus, a line connected from V18 to GND through the capacitors C8 and C9 is formed and a charge of (V17+V18)×C8/(C8+C9) is accumulated in a capacitor C9. After a sufficient charge is accumulated in the capacitor C9, the switch S3 and the switch S4 are turned off again in the section P1 of FIG. 10 and the switch S1 and the switch S2 are turned on to accumulate charge in the capacitor C8. In the subsequent section P2, the switch S1 and the switch S2 are turned off and the switch S3 and the switch S4 are turned on to accumulate charge in the capacitor C9.

The series of operations is repeated so that a charge of V17+V18 is accumulated in the capacitor C9 to generate a potential Vout6. When V17 and V18 are equal in potential and satisfy V17=V18=Vin and the capacitors C8 and C9 are equal in capacitance and satisfy C8=C9=C, Vout6 is 2*Vin, thereby obtaining double boosting output.

In the period of P1 of FIG. 10, the switching element S4 is turned off and charge is not transferred to the capacitor C9. Further, when a load is connected to the output line Vout6, the capacitor C9 is discharged by current flowing to the load. Thus, when the switching element S4 is turned off, the output voltage Vout6 gradually decreases.

The following will describe a boosting operation when a reference voltage is inverted relative to a GND potential and is outputted and a negative potential is obtained as an output.

FIG. 11 is a circuit diagram showing the configuration of a −1-fold booster circuit.

FIG. 12 is a timing chart showing control signals supplied to the booster circuit. Control signals a and b are adjusted in pulse width so that “H” sections of the signals do not overlap each other. Switching elements S1, S2, S3, and S4 are controlled by these two signals.

When such control signals a and b are supplied to the booster circuit shown in FIG. 11, the switching elements S1 and S2 are first turned on in a section P1 of FIG. 12, whereas the switching elements S3 and S4 are turned off. Thus, a capacitor C10 is connected between a potential V19 and GND and a charge of V19 is accumulated in the capacitor C10. After a sufficient charge is accumulated in the capacitor C10, the switch S1 and the switch S2 are turned off.

Then, in a section P2 of FIG. 12, the switch S3 and the switch S4 are turned on. Thus, a line connected from GND through the capacitors C10 and C11 to GND is formed and a charge of (V0−V19)×C10/(C10+C11) is accumulated in the capacitor C11. After a sufficient charge is accumulated in the capacitor C11, the switch S3 and the switch S4 are turned off again in section P1 of FIG. 12 and the switch S1 and the switch S2 are turned on to accumulate charge in the capacitor C10.

In the subsequent section P2 of FIG. 12, the switch S1 and the switch S2 are turned off and the switch S3 and the switch S4 are turned on to accumulate charge in the capacitor C11. The series of operations is repeated so that a charge of −V19 is accumulated in the capacitor C11 and a potential Vout7 is generated.

The conventional power supply performs a boosting operation by means of the above configuration and generates a power supply voltage for driving liquid crystal.

However, in a boosting operation of the conventional power supply, a double booster circuit requires two capacitors, a triple booster circuit requires three capacitors, and −1-fold booster circuit requires two capacitors. Generally speaking, when a positive potential is generated, an m-fold booster circuit requires m capacitors. When a negative potential is generated, a −n-fold booster circuit requires (n+1) capacitors. Further, in the case where the positive and negative potentials are simultaneously generated, for example, when a double boosting voltage and a −1-fold boosting voltage are necessary, four capacitors are required. In general, when a positive m-fold boosting potential and a negative n-fold boosting potential are simultaneously boosted and outputted, m+n+1 capacitors are necessary.

These capacitors have large capacitances for stabilizing output voltage. When a power supply including a booster circuit is integrated, it is difficult to form the capacitors with large capacitances on a semiconductor substrate. Even if the capacitors can be formed, the circuit increases in size.

Moreover, also when the capacitors are external components, an increase in the number of components expands an overall module area during the LSI implementation. Hence, it is desirable to minimize the number of capacitors required for a booster circuit.

### DISCLOSURE OF THE INVENTION

The present invention is devised to solve the conventional problems and has an object to provide a power supply which can reduce the number of capacitors provided as components required for boosting, simplify a circuit configuration, reduce the number of external components, and reduce the current consumption of a booster circuit and an electronics device integrated as a voltage supply source from the booster circuit.

In order to solve the problems, a power supply according to claim 1 of the present invention, which has a charge pump circuit for performing a charging operation and a pumping operation and generates a plurality of power sources through the charging operation and the pumping operation of the charge pump circuit, the charge pump circuit comprising a capacitor for operating the charging operation, the capacitor being shared by the charging operation for generating a first power source from the plurality of power sources and the charging operation for generating a second power source from the plurality of power sources.

Further, a power supply according to claim 2 of the present invention, which has a charge pump circuit for performing a charging operation and a pumping operation and generates a plurality of power sources through the charging operation and the pumping operation of the charge pump circuit, the power supply comprising: a capacitor which is shared by, in the charge pump circuit, a charging operation for generating a first power source from the plurality of power sources and a charging operation for generating a second power source from the plurality of power sources, a first control circuit for controlling the generation of the first power source and the second power source, a second control circuit different from the first control circuit, and a unit for switching the first control circuit and the second control circuit, wherein the switching unit performs switching from the first control circuit to the second control circuit to generate the first power source and a third power source which is different in output voltage from the first power source and the second power source.

A power supply according to claim 3 of the present invention is the power supply of claim 1, in which a plurality of capacitors are provided for performing the charging operation, the power supply comprising a first connector which connects one terminal of a first capacitor of the plurality of the capacitors to a first potential serving as a predetermined potential and connects the other terminal of the first capacitor to a second potential serving as a predetermined potential different from the first potential, a second connector which switches the connection of one terminal of the first capacitor from the first potential to a first line, switches the connection of the other terminal of the first capacitor to a third potential having a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of a third capacitor of the plurality of capacitors to a sixth potential serving as a predetermined potential different from the first potential, the second potential, the third potential, the fourth potential, and the fifth potential, and connects the other terminal of the third capacitor to the second line, and a controller which performs the switching operation and the connecting operation of the second connector after performing the connecting operation of the first connector and performs the connecting operation of the third connector after performing the connecting operation of the first connector again.

Further, a power supply according to claim 12 of the present invention is the power supply of claim 2, in which a plurality of capacitors are provided for performing the charging operation, the power supply comprising a first connector which connects one terminal of a first capacitor of the plurality of the capacitors to a first potential serving as a predetermined potential and connects the other terminal of the first capacitor to a second potential serving as a predetermined potential different from the first potential, a second connector which switches the connection of one terminal of the first capacitor from the first potential to a first line, switches the connection of the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of a third capacitor of the plurality of capacitors to a sixth potential serving as a predetermined potential different from the first potential, the second potential, the third potential, the fourth potential, and the fifth potential, and connects the other terminal of the third capacitor to the second line, and a controller which performs the switching operation and the connecting operation of the second connector after performing the connecting operation of the first connector and performs the connecting operation of the third connector after performing the connecting operation of the first connector again.

With this configuration, in the charge pump circuit, one capacitor is shared by the charging operation for generating the first power source from one output terminal and the charging operation for generating the second power source from the other output terminal, and charge having been accumulated in the first capacitor by a pumping operation is redistributed to the second capacitor by the switching operation and the connecting operation of the second connector after the first potential is charged to the first capacitor by the connecting operation of the first connector. Thereafter, charge having been accumulated in the first capacitor by the pumping operation is redistributed to the third capacitor by the connecting operation of the third connector after the first potential is charged to the first capacitor by the connecting operation of the first connector. A seventh potential and an eighth potential can be obtained by repeating the four connecting operations, so that only a single capacitor is necessary unlike the conventional art requiring two capacitors.

A power supply according to claim 4 of the present invention is the power supply of claim 1, in which a plurality of capacitors are provided for performing the charging operation, the power supply comprising a first connector which connects one terminal of a first capacitor of the plurality of the capacitors to a first potential serving as a predetermined potential and connects the other terminal of the first capacitor to a second potential serving as a predetermined potential different from the first potential, a second connector which switches the connection of one terminal of the first capacitor from the first potential to a first line, connects the other terminal of the first capacitor to a third potential serving as a predetermined potential different from the first potential and the second potential, connects the other terminal of the first capacitor to the third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a fourth connector which connects one terminal of the second capacitor to a third line and connects the other terminal of the second capacitor to a line having the third potential, and a controller which performs the switching operation and the connecting operation of the second connector after performing the connecting operation of the first connector and performs the connecting operation of the fourth connector after performing the connecting operation of the first connector again.

A power supply according to claim 13 of the present invention is the power supply of claim 2, in which a plurality of capacitors are provided for performing the charging operation, the power supply comprising a first connector which connects one terminal of a first capacitor of the plurality of the capacitors to a first potential serving as a predetermined potential and connects the other terminal of the first capacitor to a second potential serving as a predetermined potential different from the first potential, a second connector which switches the connection of one terminal of the first capacitor from the first potential to a first line, connects the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a fourth connector which connects one terminal of the second capacitor to a third line and connects the other terminal of the second capacitor to a line having the third potential, and a controller which performs the switching operation and the connecting operation of the second connector after performing the connecting operation of the first connector and performs the connecting operation of the fourth connector after performing the connecting operation of the first connector again.

With this configuration, in the charge pump circuit, one capacitor is shared by the charging operation for generating the first power source from one output terminal and the charging operation for generating the second power source from the other output terminal, and charge having been accumulated in the first capacitor by a pumping operation is redistributed to the second capacitor by the switching operation and the connecting operation of the second connector after the first potential is charged to the first capacitor by the connecting operation of the first connector. Thereafter, charge having been accumulated in the second capacitor by the pumping operation is redistributed to the third capacitor by the connecting operation of the fourth connector after the first potential is charged to the first capacitor by the connecting operation of the first connector. A ninth potential and a tenth potential can be obtained by repeating the four connecting operations, so that only a single capacitor is necessary unlike the conventional art requiring two capacitors.

A power supply according to claim 5 of the present invention is the power supply of claim 1, in which a plurality of capacitors are provided for performing the charging operation, the power supply comprising a first connector which connects one terminal of a first capacitor of the plurality of the capacitors to a first potential serving as a predetermined potential and connects the other terminal of the first capacitor to a second potential serving as a predetermined potential different from the first potential, a second connector which switches the connection of one terminal of the first capacitor from the first potential to a first line, switches the connection of the other terminal of the first capacitor to a third potential serving as a predetermined potential different from the first potential and the second potential, connects one terminal of a second capacitor of the plurality of capacitors to the first line, connects one terminal of the second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of the third capacitor of the plurality of capacitors to a sixth potential serving as a predetermined potential different from the first potential, the second potential, the third potential, the fourth potential, and the fifth potential, and connects the other terminal of the third capacitor to the second line, a fourth connector which connects one terminal of the second capacitor to a third line and connects the other terminal of the second capacitor to a line having the third potential, a first controller which performs the switching operation and the connecting operation of the second connector after performing the connecting operation of the first connector and performs the connecting operation of the third connector after performing the connecting operation of the first connector again, and a second controller which performs the switching operation and the connecting operation of the second connector after performing the connecting operation of the first connector and performs the connecting operation of the fourth connector after performing the connecting operation of the first connector again, wherein the first controller and the second controller can be switched according to a necessary power source of the plurality of power sources.

A power supply according to claim 13 of the present invention is the power supply of claim 2, which has a plurality of capacitors for performing the charging operation, comprising a first connector for connecting one terminal of a first capacitor of the plurality of the capacitors to a first potential serving as a predetermined potential and connecting the other terminal of the first capacitor to a second potential having a predetermined potential different from the first potential, a second connector for switching the connection of one terminal of the first capacitor from the first potential to a first line, connecting the other terminal of the first capacitor to a third potential having a predetermined potential different from the first potential and the second potential, connecting one terminal of a second capacitor of the plurality of capacitors to the first line, and connecting the other terminal of the second capacitor to a fourth potential having a predetermined potential different from the first potential, the second potential, and the third potential, a third connector for connecting one terminal of the first capacitor to a fifth potential having a predetermined potential different from the first potential, the second potential, the third potential, and the fourth potential, connecting the other terminal of the first capacitor to a second line different from the first line, connecting one terminal of the third capacitor of the plurality of capacitors to a sixth potential having a predetermined potential different from the first potential, the second potential, the third potential, the fourth potential, and the fifth potential, and connecting the other terminal of the third capacitor to the second line, a fourth connector for connecting one terminal of the second capacitor to a third line and connecting the other terminal of the second capacitor to a line having the third potential, a first controller which performs the switching and connecting operations of the second connector after the connecting operation of the first connector and performs the connecting operation of the third connector after performing the connecting operation of the first connector again, and a second controller which performs the switching and connecting operations of the second connector after the connecting operation of the first connector and performs the connecting operation of the fourth connector after performing the connecting operation of the first connector again, wherein the first controller and the second controller can be switched according to a necessary power source of the plurality of power sources.

With these configurations, in the charge pump circuit, one capacitor is shared by the charging operation for generating the first power source from one output terminal and the charging operation for generating the second power source from the other output terminal. Thereafter, switching is performed as necessary between control for performing the switching operation and the connecting operation of the second connector after the connecting operation of the first connector, performing the connecting operation of the third connector after the connecting operation of the first connector, and obtaining a seventh potential and an eighth potential, and control for performing the switching operation and the connecting operation of the second connector after the connecting operation of the first connector, performing the connecting operation of the fourth connector after the connecting operation of the first connector, and obtaining a ninth potential and a tenth potential, and thus two kinds of combinations of outputs having different potentials can be obtained as output voltages. Hence, only a single capacitor is necessary unlike the conventional art requiring two capacitors.

As described above, in the charge pump circuit, one capacitor is shared by the charging operation for generating, e.g., the first power source, which is a double boosting output of Vin, from one output terminal and a charging operation for generating, e.g., the second power source, which is a −1-fold boosting output of Vin, from the other output terminal. The first control circuit is connected to the charge pump circuit to generate the first power source and the second power source. Thereafter, the connection of the charge pump circuit is switched from the first control circuit to the second control circuit, so that it is possible to generate, for example, the first power source and the third power source, which is a triple boosting output of Vin, from the output terminal for generating the second power source.

Therefore, it is possible to reduce the number of capacitors provided as components required for boosting, simplify the circuit configuration, reduce the number of external components, and reduce the current consumption of a booster circuit and an electronics device integrated as a voltage supply source from the booster circuit.

### BRIEF DESCRIPTION OF THE DRAWINGS

FIG. 1 is a block diagram showing a configuration of a power supply according to Embodiment 1 of the present invention;

FIG. 2 is a circuit diagram showing the configuration of the power supply according to Embodiment 1;

FIG. 3 is a time chart showing control signals (1) of the power supply according to Embodiment 1;

FIG. 4 is a time chart showing control signals (2) of the power supply according to Embodiment 1;

FIG. 5 is a block diagram showing a configuration of a power supply according to Embodiment 2 of the present invention;

FIG. 6 is a circuit diagram showing the configuration of the power supply according to Embodiment 2;

FIG. 7 is a time chart showing control signals (1) of the power supply according to Embodiment 2;

FIG. 8 is a time chart showing control signals (2) of the power supply according to Embodiment 2;

FIG. 9 is a circuit diagram showing a configuration of a double booster circuit in a conventional power supply;

FIG. 10 is a time chart showing control signals of the double booster circuit in the conventional power supply;

FIG. 11 is a circuit diagram showing a configuration of a −1-fold booster circuit in the conventional power supply; and

FIG. 12 is a time chart showing control signals of the −1-fold booster circuit in the conventional power supply.

### DESCRIPTION OF THE EMBODIMENTS

The following will specifically describe power supplies according to embodiments of the present invention with reference to the accompanying drawings.

### Embodiment 1

A power supply according to Embodiment 1 of the present invention will be discussed below. The following will describe an example where a positive potential double boosting output and a negative potential −1-fold boosting output are obtained, and an example where a positive potential double boosting output and a positive potential triple boosting output are obtained.

FIG. 1 is a block diagram showing the configuration of the power supply according to Embodiment 1. The power supply of Embodiment 1 is constituted of a first control circuit 10, a second control circuit 20, and a first booster circuit (charge pump circuit) 30. In this case, a switch connecting the first booster circuit 30 to the first control circuit 10 or the second control circuit 20 shown in FIG. 1 is flipped up and the first control circuit 10 is connected to the first booster circuit 30.

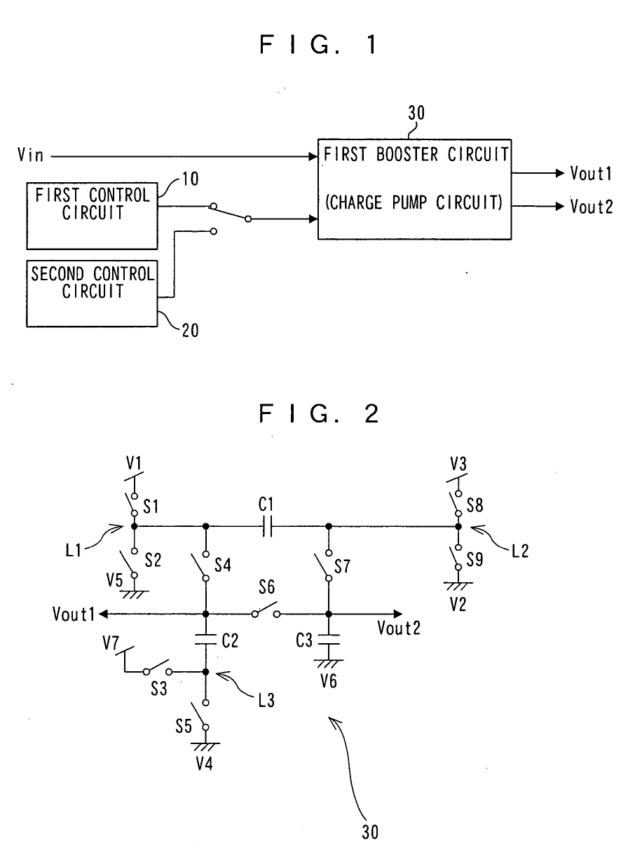

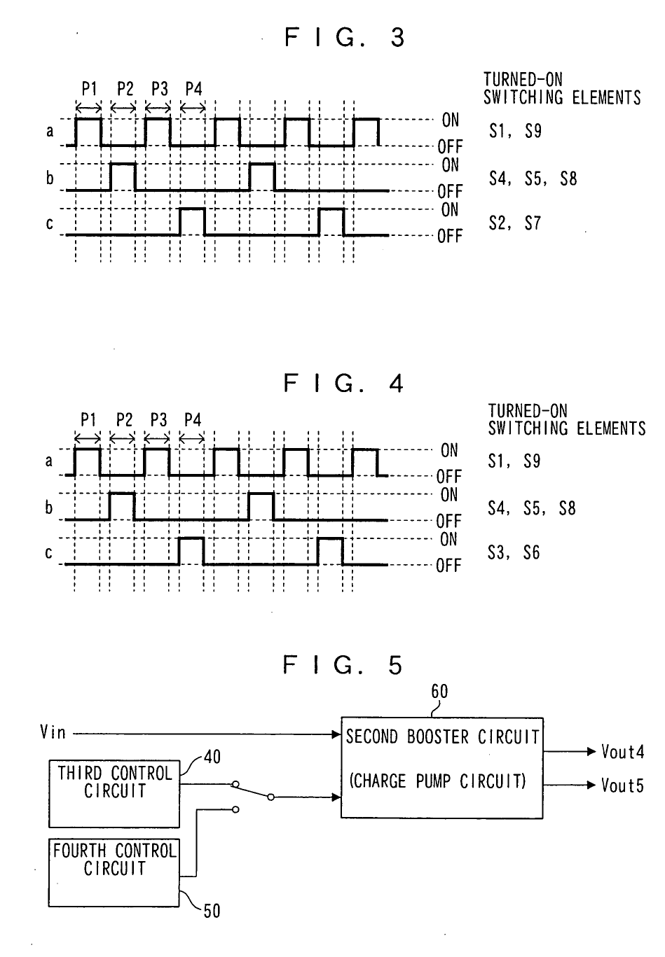

FIG. 2 is a circuit diagram showing the detail of the first booster circuit 30 in the power supply according to Embodiment 1. FIG. 3 shows the signals of the first control circuit 10 for driving the booster circuit. Control signals a, b, and c are adjusted in pulse width so that “H” sections of the signals do not overlap one another. Referring to FIGS. 2 and 3, operations will be discussed in detail.

First, in a section P1 (the relationship between “H” and “L” of waveforms and “ON” and “OFF” of the switch is similar to that of conventional art) of FIG. 3, a terminal L1 is connected to a power source V1 and a terminal L2 is connected to a power source V2. With this connection, a voltage of V1−V2 is charged to a capacitor C1. Then, in a section P2 of FIG. 3, the terminal L2 is connected to a power source V3 and the terminal L1 is connected to an output terminal Vout1. That is, a line connected from V3 to V4 through the capacitors C1 and C2 is formed and the output terminal Vout1 has a potential of V3+V1−V2 obtained by adding a potential V1−V2, which has been accumulated in the capacitor C1, to the voltage V3. When V1=V3=Vin and V2=V4=0 (ground potential (GND)) are satisfied, Vout1=2*Vin is determined and thus double boosting is realized.

Subsequently, in a section P3 of FIG. 3, the terminal L1 is connected to the power source V1 and the terminal L2 is connected to the power source V2 as in the section P1. With this connection, a voltage of V1−V2 is charged to the capacitor C1. Then, in a section P4, the terminal L1 is connected to a power source V5 and the terminal L2 is connected to an output terminal Vout2. At this point, the Vout2 has a potential obtained by subtracting a voltage of V1−V2, which has been accumulated in the capacitor C1, from the potential of V5, so that the output terminal Vout2 has a potential of V5−V1+V2. When V1=Vin and V2=V5=0 are satisfied, Vout2=−Vin is determined and thus −1-fold boosting is realized.

The following will describe the case where the switch for connecting the first booster circuit 30 to the first control circuit 10 or the second control circuit 20 of FIG. 1 is flipped down and the second control circuit 20 is connected to the first booster circuit 30. FIG. 4 shows the signals of the second control circuit 20 for driving the booster circuit.

First, in a section P1 of FIG. 4, the terminal L1 is connected to the power source V1 and the terminal L2 is connected to the power source V2. With this connection, a voltage of V1−V2 is charged to the capacitor C1. Then, in a section P2 of FIG. 4, the terminal L2 is connected to the power source V3 and the terminal L1 is connected to the output terminal Vout1. That is, a line connected from V3 to V4 through the capacitors C1 and C2 is formed and the output terminal Vout1 has a potential of V3+V1−V2 obtained by adding a potential V1−V2, which has been accumulated in a capacitor C1, to the voltage of V3.

Subsequently, in a section P3 of FIG. 4, the terminal L1 is connected to the power source V1 and the terminal L2 is connected to the power source V2 as in the section P1.

Then, in a section P4 of FIG. 4, the terminal L3 is connected to a power source V7 and the output terminal Vout1 is connected to the output terminal Vout2. Hence, a line connected from V7 to V6 through the capacitors C2 and C3 is formed, and the output terminal Vout2 has a potential of V7+V3+V1−V2 obtained by adding a potential V3+V1−V2, which has been accumulated in the capacitor C2, to the voltage of V7. When V1=V3=V7=Vin and V2=0 are satisfied, Vout1=3*Vin is determined and thus triple boosting is realized.

### Embodiment 2

A power supply according to Embodiment 2 of the present invention will be discussed below. The following will describe an example where the outputs of positive potential triple boosting and negative potential −1-fold boosting are obtained, and an example where the outputs of positive potential triple boosting and positive potential quadruple boosting are obtained.

FIG. 5 a block diagram showing the configuration of the power supply according to Embodiment 2. The power supply of Embodiment 2 is constituted of a third control circuit 40, a fourth control circuit 50, and a second booster circuit 60. In this case, a switch connecting the second booster circuit 60 to the third control circuit 40 or the fourth control circuit 50 is flipped up and the third control circuit 40 is connected to the second booster circuit 60.

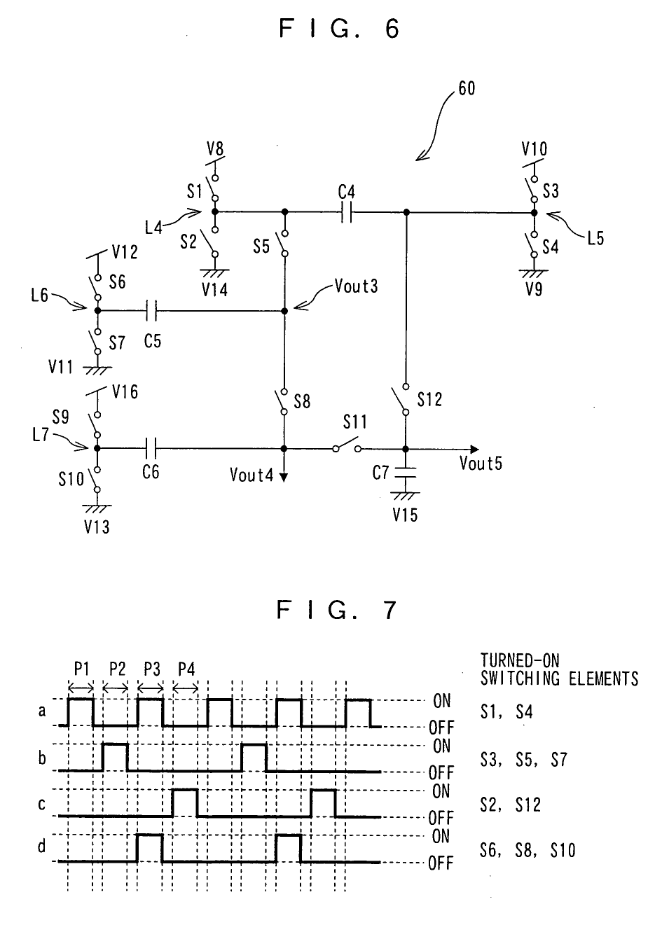

FIG. 6 is a circuit diagram showing the detail of the second booster circuit 60. FIG. 7 shows the signals of the third control circuit 40 for driving the booster circuit. Control signals a, b, c and d of FIG. 7 are adjusted in pulse width so that “H” sections of the signals do not overlap one another. Referring to FIGS. 6 and 7, operations will be discussed in detail.

First, in a section P1 of FIG. 7, a terminal L4 is connected to a power source V8 and a terminal L5 is connected to a power source V9. With this connection, a voltage of V8−V9 is charged to a capacitor C4. Then, in a section P2 of FIG. 7, the terminal L5 is connected to a power source V10 and the terminal L4 is connected to an output terminal Vout3. That is, a line connected from V10 to V11 through the capacitors C4 and C5 is formed and the output terminal Vout3 has a potential of V10+V8−V9 obtained by adding the voltage of V10 to a potential V8−V9, which has been accumulated in the capacitor C4.

Subsequently, in a section P3 of FIG. 7, the output terminal Vout3 is connected to an output terminal Vout4, a terminal L6 is connected to a power source V12, and a terminal L7 is connected to a power source V13. That is, a line connected from V12 to V13 through the capacitors C5 and C6 is formed and the output terminal Vout3 has a potential of V12+V10+V8−V9 obtained by adding the voltage of V12 to a potential V10+V8−V9, which has been accumulated in the capacitor C5. When V8=V10=V12=Vin and V9=0 are satisfied, the output voltage Vout3 has 3*Vin and thus triple boosting is realized. Further, the terminal L4 is connected to the power source V8 and the terminal L5 is connected to the power source V9, so that a voltage of V8−V9 is charged to the capacitor C4.

Then, in a section P4 of FIG. 7, the terminal L4 is connected to a power source V14 and the terminal L5 is connected to an output terminal Vout5. At this point, the output terminal Vout5 has a potential obtained by subtracting a voltage V8−V9, which has been accumulated in the capacitor C4, from the potential V14, so that the output terminal Vout5 has V14−V8+V9. When V8=Vin and V9=V14=0 are satisfied, Vout5=−Vin is determined and thus −1-fold boosting is realized.

The following will describe the case where the switch for connecting the second booster circuit 60 to the third control circuit 40 or the fourth control circuit 50 of FIG. 5 is flipped down and the fourth control circuit 50 is connected to the second booster circuit 60.

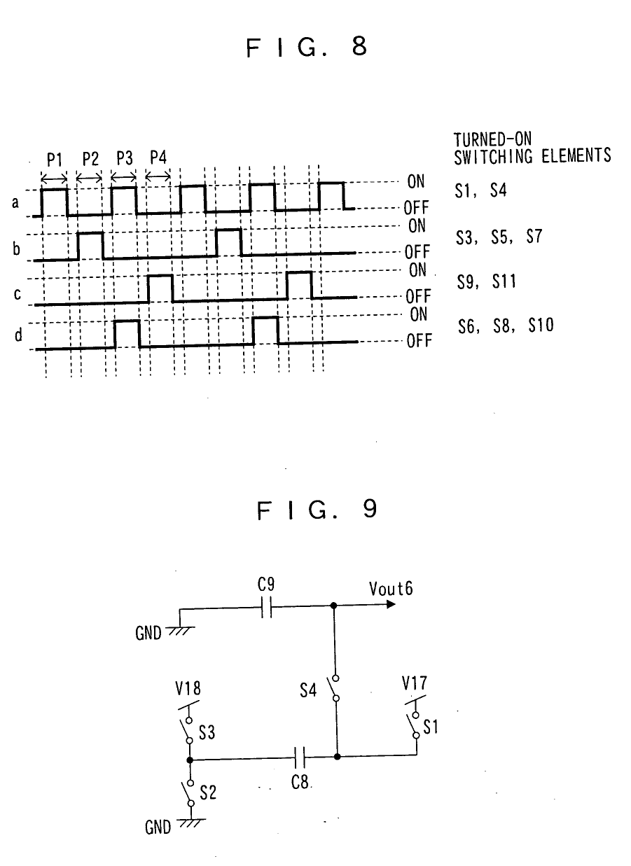

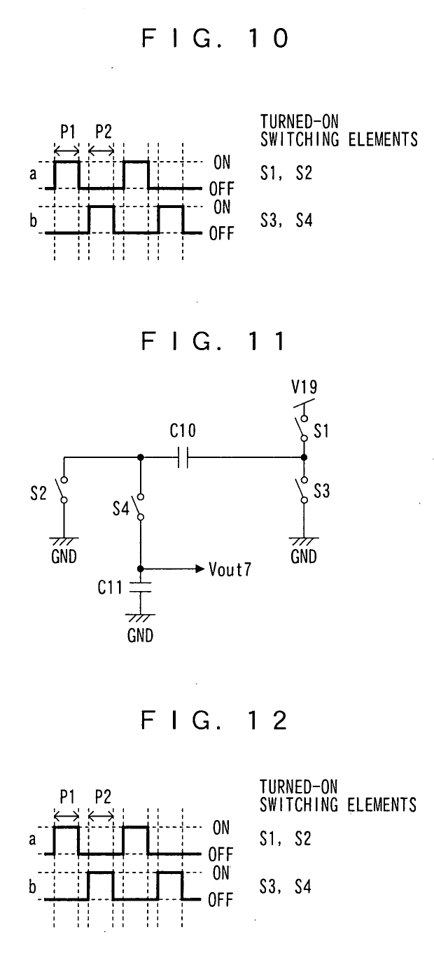

FIG. 8 shows the signals of the fourth control circuit 50 for driving the booster circuit. First, in a section P1 of FIG. 8, the terminal L4 is connected to the power source V8 and the terminal L5 is connected to the power source V9. With this connection, a voltage of V8−V9 is charged to the capacitor C4. Then, in a section P2 of FIG. 8, the terminal L5 is connected to the power source V10 and the terminal L4 is connected to the output terminal Vout3. That is, a line connected from V10 to V11 through the capacitors C4 and C5 is formed and the output terminal Vout3 has a potential of V10+V8−V9 obtained by adding a potential V8−V9, which has been accumulated in the capacitor C4, to the voltage of Subsequently, in a section P3 of FIG. 8, the output terminal Vout3 is connected to the output terminal Vout4, the terminal L6 is connected to the power source V12, and the terminal L7 is connected to the power source V13. That is, a line connected from V12 to V13 through the capacitors C5 and C6 is formed and the output terminal Vout3 has a potential of V12+V10+V8−V9 obtained by adding a potential V10+V8−V9, which has been accumulated in the capacitor C5, to the voltage of V12.

Then, in a section P4 of FIG. 8, the terminal L7 is connected to a power source V16 and the output terminal Vout4 is connected to the output terminal Vout5. Thus, a line connected from V16 to V15 through capacitors C6 and C7 is formed and the output terminal Vout5 has a potential of V16+V12+V10+V8−V9 obtained by adding a potential V12+V10+V8−V8−V9, which has been accumulated in the capacitor C6, to the voltage of V16. When V8=V10=V12=V16=Vin and V9=0 are satisfied, the output voltage Vout5 is 4*Vin and thus quadruple boosting is realized.

As examples of the use of the first control circuit 10 or the third control circuit 40, the above embodiments described the outputs of double boosting and −1-fold boosting and the outputs of triple boosting and −1-fold boosting. In a booster circuit using (n+1) capacitors which simultaneously obtain a positive potential n-fold boosting output and a negative potential −1-fold boosting output, n*Vin of n-fold boosting output can be obtained by performing a pumping operation for accumulating, in an n-th capacitor, charge of (n−1)*Vin which is (n−1) times as high as the reference voltage Vin. According to this description, the outputs of n-fold boosting and −1-fold boosting can be simultaneously obtained in the present invention. n represents an integer of 2 or larger.

Moreover, as examples of the use of the control circuit 20 or the control circuit 50, the embodiments described the outputs of double boosting and triple boosting and the outputs of triple boosting and quadruple boosting. In an i-fold booster circuit using i capacitors for boosting and outputting a positive potential, i-fold boosting output can be obtained by accumulating, in an i-th capacitor, charge which is i−1 times as high as the reference voltage Vin. According to this description, the positive voltage i-fold boosting output and the positive voltage i−1-fold boosting output can be simultaneously obtained in the present invention. i represents an integer of 2 or larger.

Further, the switches of the embodiments may be constituted of an N-channel transistor, a P-channel transistor, or a switching circuit using both of the N-channel transistor and the P-channel transistor with the same effect.

1. A power supply, which has a charge pump circuit for performing a charging operation and a pumping operation and generates a plurality of power sources through the charging operation and the pumping operation of the charge pump circuit, the charge pump circuit comprising a capacitor for operating the charging operation, the capacitor being shared by a charging operation for generating a first power source from the plurality of power sources and a charging operation for generating a second power source from the plurality of power sources.

2. A power supply, which has a charge pump circuit for performing a charging operation and a pumping operation and generates a plurality of power sources through the charging operation and the pumping operation of the charge pump circuit, the power supply comprising: a capacitor which is shared by, in the charge pump circuit, a charging operation for generating a first power source from the plurality of power sources and a charging operation for generating a second power source from the plurality of power sources, a first control circuit for controlling generation of the first power source and the second power source, a second control circuit different from the first control circuit, and a unit for switching the first control circuit and the second control circuit, wherein the switching unit performs switching from the first control circuit to the second control circuit to generate the first power source and a third power source which is different in output voltage from the first power source and the second power source.

3. The power supply according to claim 1, wherein a plurality of capacitors are provided for performing the charging operation, the power supply comprising: a first connector which connects one terminal of a first capacitor of the plurality of the capacitors to a first potential serving as a predetermined potential and connects the other terminal of the first capacitor to a second potential serving as a predetermined potential different from the first potential, a second connector which switches a connection of one terminal of the first capacitor from the first potential to a first line, switches a connection of the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of a third capacitor of the plurality of capacitors to a sixth potential serving as a predetermined potential different from the first potential, the second potential, the third potential, the fourth potential, and the fifth potential, and connects the other terminal of the third capacitor to the second line, and a controller which performs a switching operation and a connecting operation of the second connector after performing a connecting operation of the first connector and performs a connecting operation of the third connector after performing the connecting operation of the first connector again.

4. The power supply according to claim 1, wherein a plurality of capacitors are provided for performing the charging operation, the power supply comprising: a first connector which connects one terminal of a first capacitor of the plurality of the capacitors to a first potential serving as a predetermined potential and connects the other terminal of the first capacitor to a second potential serving as a predetermined potential different from the first potential, a second connector which switches a connection of one terminal of the first capacitor from the first potential to a first line, connects the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a fourth connector which connects one terminal of the second capacitor to a third line and connects the other terminal of the second capacitor to a line having the third potential, and a controller which performs a switching operation and a connecting operation of the second connector after performing a connecting operation of the first connector and performs a connecting operation of the fourth connector after performing the connecting operation of the first connector again.

5. The power supply according to claim 1, wherein a plurality of capacitors are provided for performing the charging operation, the power supply comprising: a first connector which connects one terminal of a first capacitor of the plurality of the capacitors to a first potential serving as a predetermined potential and connects the other terminal of the first capacitor to a second potential serving as a predetermined potential different from the first potential, a second connector which switches a connection of one terminal of the first capacitor from the first potential to a first line, switches a connection of the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of the third capacitor of the plurality of capacitors to a sixth potential serving as a predetermined potential different from the first potential, the second potential, the third potential, the fourth potential, and the fifth potential, and connects the other terminal of the third capacitor to the second line, a fourth connector which connects one terminal of the second capacitor to a third line and connects the other terminal of the second capacitor to a line having the third potential, a first controller which performs a switching operation and a connecting operation of the second connector after performing a connecting operation of the first connector and performs a connecting operation of the third connector after performing the connecting operation of the first connector again, and a second controller which performs the switching operation and the connecting operation of the second connector after performing the connecting operation of the first connector and performs a connecting operation of the fourth connector after performing the connecting operation of the first connector again, wherein the first controller and the second controller can be switched according to a necessary power source of the plurality of power sources.

6. The power supply according to claim 1, wherein a plurality of capacitors are provided for performing the charging operation, the power supply comprising: a fourth connector which connects one terminal of a fourth capacitor of the plurality of the capacitors to an eighth potential serving as a predetermined potential and connects the other terminal of the fourth capacitor to a ninth potential serving as a predetermined potential, a fifth connector which connects one terminal of the fourth capacitor to a third line, connects the other terminal of the fourth capacitor to a tenth potential serving as a predetermined potential different from the eighth potential and the ninth potential, connects one terminal of a fifth capacitor of the plurality of capacitors to the third line, and connects the other terminal of the fifth capacitor to an eleventh potential serving as a predetermined potential different from the eighth potential, the ninth potential, and the tenth potential, a sixth connector which switches one terminal of the fifth capacitor from a fifth line to a sixth line, connects the other terminal of the fifth capacitor to a twelfth potential serving as a predetermined potential different from the eighth potential, the ninth potential, the tenth potential, and the eleventh potential, connects one terminal of a sixth capacitor of the plurality of capacitors to the sixth line, and connects the other terminal of the sixth capacitor to the eleventh potential, a seventh connector which connects one terminal of the fourth capacitor to a fourteenth potential serving as a predetermined potential different from the eighth potential, the ninth potential, the tenth potential, the eleventh potential, and the twelfth potential, connects the other terminal of the fourth capacitor to a fourth line, connects one terminal of a seventh capacitor of the plurality of capacitors to a fifteenth potential serving as a predetermined potential different from the eighth potential, the ninth potential, the tenth potential, the eleventh potential, the twelfth potential, and the fourteenth potential, and switches a connection of the other terminal of the seventh capacitor to the second line, and a controller which performs a connecting operation of the fifth connector after performing a connecting operation of the fourth connector and performs a connecting operation of the seventh connector after simultaneously performing connecting operations of the fourth connector and the sixth connector again.

7. The power supply according to claim 1, wherein a plurality of capacitors are provided for performing the charging operation, the power supply comprising: a fourth connector which connects one terminal of a fourth capacitor of the plurality of the capacitors to an eighth potential serving as a predetermined potential and connects the other terminal of the fourth capacitor to a ninth potential serving as a predetermined potential, a fifth connector which switches a connection of one terminal of the fourth capacitor from the eighth potential to a third line, connects the other terminal of the fourth capacitor to a tenth potential serving as a predetermined potential different from the eighth potential and the ninth potential, connects one terminal of a fifth capacitor of the plurality of capacitors to the third line, and connects the other terminal of the fifth capacitor to an eleventh potential serving as a predetermined potential different from the eighth potential, the ninth potential, and the tenth potential, a sixth connector which switches one terminal of the fifth capacitor from a fifth line to a sixth line, connects the other terminal of the fifth capacitor to a twelfth potential serving as a predetermined potential different from the eighth potential, the ninth potential, the tenth potential, and the eleventh potential, connects one terminal of a sixth capacitor of the plurality of capacitors to the sixth line, and connects the other terminal of the sixth capacitor to the eleventh potential, an eighth connector which connects one terminal of the sixth capacitor to the sixth line, connects the other terminal of the sixth capacitor to a sixteenth potential serving as a predetermined potential different from the eighth potential, the ninth potential, the tenth potential, the eleventh potential, and the twelfth potential, connects one terminal of a seventh capacitor of the plurality of capacitors to a fifteenth potential serving as a predetermined potential different from the eighth potential, the ninth potential, the tenth potential, the eleventh potential, the twelfth potential, and the sixteenth potential, and switches a connection of the other terminal of the seventh capacitor to the sixth line, and a controller which performs a switching operation and a connecting operation of the fifth connector after performing a connecting operation of the fourth connector and subsequently performs a connecting operation of the eighth connector after performing a connecting operation of the sixth connector.

8. The power supply according to claim 1, wherein a plurality of capacitors are provided for performing the charging operation, the power supply comprising: a fourth connector which connects one terminal of a fourth capacitor of the plurality of the capacitors to an eighth potential serving as a predetermined potential and connects the other terminal of the fourth capacitor to a ninth potential serving as a predetermined potential, a fifth connector which switches a connection of one terminal of the fourth capacitor from the eighth potential to a third line, connects the other terminal of the fourth capacitor to a tenth potential serving as a predetermined potential different from the eighth potential and the ninth potential, connects one terminal of a fifth capacitor of the plurality of capacitors to the third line, and connects the other terminal of the fifth capacitor to an eleventh potential serving as a predetermined potential different from the eighth potential, the ninth potential, and the tenth potential, a sixth connector which switches one terminal of the fifth capacitor from a fifth line to a sixth line, connects the other terminal of the fifth capacitor to a twelfth potential serving as a predetermined potential different from the eighth potential, the ninth potential, the tenth potential, and the eleventh potential, connects one terminal of a sixth capacitor of the plurality of capacitors to the sixth line, and connects the other terminal of the sixth capacitor to the eleventh potential, a seventh connector which connects one terminal of the fourth capacitor to a fourteenth potential serving as a predetermined potential different from the eighth potential, the ninth potential, the tenth potential, the eleventh potential, and the twelfth potential, connects the other terminal of the fourth capacitor to a fourth line, connects one terminal of a seventh capacitor of the plurality of capacitors to a fifteenth potential serving as a predetermined potential different from the eighth potential, the ninth potential, the tenth potential, the eleventh potential, the twelfth potential, and the fourteenth potential, and switches a connection of the other terminal of the seventh capacitor to the second line, an eighth connector which connects one terminal of the sixth capacitor to the sixth line, connects the other terminal of the sixth capacitor to a sixteenth potential serving as a predetermined potential different from the eighth potential, the ninth potential, the tenth potential, the eleventh potential, and the twelfth potential, connects one terminal of a seventh capacitor of the plurality of capacitors to a fifteenth potential serving as a predetermined potential different from the eighth potential, the ninth potential, the tenth potential, the eleventh potential, the twelfth potential, and the sixteenth potential, and switches a connection of the other terminal of the seventh capacitor to the sixth line, a third controller which performs a connecting operation of the fifth connector after performing a connecting operation of the fourth connector and performs a connecting operation of the seventh connector after simultaneously performing connecting operations of the fourth connector and the sixth connector again, and a fourth controller which performs a switching operation and the connecting operation of the fifth connector after performing the connecting operation of the fourth connector and subsequently performs a connecting operation of the eighth connector after performing the connecting operation of the sixth connector, wherein the third controller and the fourth controller can be switched according to a necessary power source of the plurality of power sources.

9. The power supply according to claim 3, wherein the connector is constituted of a switching element for turning on/off a connection of the circuit.

10. The power supply according to claim 9, wherein the switch is constituted of an N-channel transistor, a P-channel transistor, or both of the N-channel transistor and the P-channel transistor.

11. The power supply according to claim 1, wherein each of the power sources is connected to a liquid crystal display device for displaying information by switching a voltage applied to liquid crystal and is supplied for the information display.

12. The power supply according to claim 2, wherein a plurality of capacitors are provided for performing the charging operation, the power supply comprising: a first connector which connects one terminal of a first capacitor of the plurality of the capacitors to a first potential serving as a predetermined potential and connects the other terminal of the first capacitor to a second potential serving as a predetermined potential different from the first potential, a second connector which switches a connection of one terminal of the first capacitor from the first potential to a first line, switches a connection of the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of a third capacitor of the plurality of capacitors to a sixth potential serving as a predetermined potential different from the first potential, the second potential, the third potential, the fourth potential, and the fifth potential, and connects the other terminal of the third capacitor to the second line, and a controller which performs a switching operation and a connecting operation of the second connector after performing a connecting operation of the first connector and performs a connecting operation of the third connector after performing the connecting operation of the first connector again.

13. The power supply according to claim 2, wherein a plurality of capacitors are provided for performing the charging operation, the power supply comprising: a first connector which connects one terminal of a first capacitor of the plurality of the capacitors to a first potential serving as a predetermined potential and connects the other terminal of the first capacitor to a second potential serving as a predetermined potential different from the first potential, a second connector which switches a connection of one terminal of the first capacitor from the first potential to a first line, connects the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a fourth connector which connects one terminal of the second capacitor to a third line and connects the other terminal of the second capacitor to a line having the third potential, and a controller which performs a switching operation and a connecting operation of the second connector after performing a connecting operation of the first connector and performs a connecting operation of the fourth connector after performing the connecting operation of the first connector again.

14. The power supply according to claim 2, wherein a plurality of capacitors are provided for performing the charging operation, the power supply comprising: a first connector which connects one terminal of a first capacitor of the plurality of the capacitors to a first potential serving as a predetermined potential and connects the other terminal of the first capacitor to a second potential serving as a predetermined potential different from the first potential, a second connector which switches a connection of one terminal of the first capacitor from the first potential to a first line, switches a connection of the other terminal of the first capacitor to a third potential serving as a predetermined potential different from the first potential and the second potential, connects one terminal of a second capacitor of the plurality of capacitors to the first line, and connects the other terminal of the second capacitor to a fourth potential serving as a predetermined potential different from the first potential, the second potential, and the third potential, a third connector which connects one terminal of the first capacitor to a fifth potential serving as a predetermined potential different from the first potential, the second potential, the third potential, and the fourth potential, connects the other terminal of the first capacitor to a second line different from the first line, connects one terminal of a third capacitor of the plurality of capacitors to a sixth potential serving as a predetermined potential different from the first potential, the second potential, the third potential, the fourth potential, and the fifth potential, and connects the other terminal of the third capacitor to the second line, a fourth connector which connects one terminal of the second capacitor to a third line and connects the other terminal of the second capacitor to a line having the third potential, a first controller which performs a switching operation and a connecting operation of the second connector after performing a connecting operation of the first connector and performs a connecting operation of the third connector after performing the connecting operation of the first connector again, and a second controller which performs a switching operation and a connecting operation of the second connector after performing a connecting operation of the first connector and performs a connecting operation of the fourth connector after performing the connecting operation of the first connector again, wherein the first controller and the second controller can be switched according to a necessary power source of the plurality of power sources.

15. The power supply according to claim 2, wherein a plurality of capacitors are provided for performing the charging operation, the power supply comprising: a fourth connector which connects one terminal of a fourth capacitor of the plurality of the capacitors to an eighth potential serving as a predetermined potential and connects the other terminal of the fourth capacitor to a ninth potential serving as a predetermined potential, a fifth connector which connects one terminal of the fourth capacitor to a third line, connects the other terminal of the fourth capacitor to a tenth potential serving as a predetermined potential different from the eighth potential and the ninth potential, connects one terminal of a fifth capacitor of the plurality of capacitors to the third line, and connects the other terminal of the fifth capacitor to an eleventh potential serving as a predetermined potential different from the eighth potential, the ninth potential, and the tenth potential, a sixth connector which switches one terminal of the fifth capacitor from a fifth line to a sixth line, connects the other terminal of the fifth capacitor to a twelfth potential serving as a predetermined potential different from the eighth potential, the ninth potential, the tenth potential, and the eleventh potential, connects one terminal of a sixth capacitor of the plurality of capacitors to the sixth line, and connects the other terminal of the sixth capacitor to the eleventh potential, a seventh connector which connects one terminal of the fourth capacitor to a fourteenth potential serving as a predetermined potential different from the eighth potential, the ninth potential, the tenth potential, the eleventh potential, and the twelfth potential, connects the other terminal of the fourth capacitor to a fourth line, connects one terminal of a seventh capacitor of the plurality of capacitors to a fifteenth potential serving as a predetermined potential different from the eighth potential, the ninth potential, the tenth potential, the eleventh potential, the twelfth potential, and the fourteenth potential, and switches a connection of the other terminal of the seventh capacitor to the second line, and a controller which performs a connecting operation of the fifth connector after performing a connecting operation of the fourth connector and performs a connecting operation of the seventh connector after simultaneously performing connecting operations of the fourth connector and the sixth connector again.

16. The power supply according to claim 2, wherein a plurality of capacitors are provided for performing the charging operation, the power supply comprising: a fourth connector which connects one terminal of a fourth capacitor of the plurality of the capacitors to an eighth potential serving as a predetermined potential and connects the other terminal of the fourth capacitor to a ninth potential serving as a predetermined potential, a fifth connector which switches a connection of one terminal of the fourth capacitor from the eighth potential to a third line, connects the other terminal of the fourth capacitor to a tenth potential serving as a predetermined potential different from the eighth potential and the ninth potential, connects one terminal of a fifth capacitor of the plurality of capacitors to the third line, and connects the other terminal of the fifth capacitor to an eleventh potential serving as a predetermined potential different from the eighth potential, the ninth potential, and the tenth potential, a sixth connector which switches one terminal of the fifth capacitor from a fifth line to a sixth line, connects the other terminal of the fifth capacitor to a twelfth potential serving as a predetermined potential different from the eighth potential, the ninth potential, the tenth potential, and the eleventh potential, connects one terminal of a sixth capacitor of the plurality of capacitors to the sixth line, and connects the other terminal of the sixth capacitor to the eleventh potential, an eighth connector which connects one terminal of the sixth capacitor to the sixth line, connects the other terminal of the sixth capacitor to a sixteenth potential serving as a predetermined potential different from the eighth potential, the ninth potential, the tenth potential, the eleventh potential, and the twelfth potential, connects one terminal of a seventh capacitor of the plurality of capacitors to a fifteenth potential serving as a predetermined potential different from the eighth potential, the ninth potential, the tenth potential, the eleventh potential, the twelfth potential, and the sixteenth potential, and switches a connection of the other terminal of the seventh capacitor to the sixth line, and a controller which performs a switching operation and a connecting operation of the fifth connector after performing a connecting operation of the fourth connector and subsequently performs a connecting operation of the eighth connector after performing a connecting operation of the sixth connector.

17. The power supply according to claim 2, wherein a plurality of capacitors are provided for performing the charging operation, the power supply comprising: a fourth connector which connects one terminal of a fourth capacitor of the plurality of the capacitors to an eighth potential serving as a predetermined potential and connects the other terminal of the fourth capacitor to a ninth potential serving as a predetermined potential, a fifth connector which switches a connection of one terminal of the fourth capacitor from the eighth potential to a third line, connects the other terminal of the fourth capacitor to a tenth potential serving as a predetermined potential different from the eighth potential and the ninth potential, connects one terminal of a fifth capacitor of the plurality of capacitors to the third line, and connects the other terminal of the fifth capacitor to an eleventh potential serving as a predetermined potential different from the eighth potential, the ninth potential, and the tenth potential, a sixth connector which switches one terminal of the fifth capacitor from a fifth line to a sixth line, connects the other terminal of the fifth capacitor to a twelfth potential serving as a predetermined potential different from the eighth potential, the ninth potential, the tenth potential, and the eleventh potential, connects one terminal of a sixth capacitor of the plurality of capacitors to the sixth line, and connects the other terminal of the sixth capacitor to the eleventh potential, a seventh connector which connects one terminal of the fourth capacitor to a fourteenth potential serving as a predetermined potential different from the eighth potential, the ninth potential, the tenth potential, the eleventh potential, and the twelfth potential, connects the other terminal of the fourth capacitor to a fourth line, connects one terminal of a seventh capacitor of the plurality of capacitors to a fifteenth potential serving as a predetermined potential different from the eighth potential, the ninth potential, the tenth potential, the eleventh potential, the twelfth potential, and the fourteenth potential, and switches a connection of the other terminal of the seventh capacitor to the second line, an eighth connector which connects one terminal of the sixth capacitor to the sixth line, connects the other terminal of the sixth capacitor to a sixteenth potential serving as a predetermined potential different from the eighth potential, the ninth potential, the tenth potential, the eleventh potential, and the twelfth potential, connects one terminal of a seventh capacitor of the plurality of capacitors to a fifteenth potential serving as a predetermined potential different from the eighth potential, the ninth potential, the tenth potential, the eleventh potential, the twelfth potential, and the sixteenth potential, and switches a connection of the other terminal of the seventh capacitor to the sixth line, a third controller which performs a connecting operation of the fifth connector after performing a connecting operation of the fourth connector and performs a connecting operation of the seventh connector after simultaneously performing connecting operations of the fourth connector and the sixth connector again, and a fourth controller which performs a switching operation and the connecting operation of the fifth connector after performing the connecting operation of the fourth connector and subsequently performs a connecting operation of the eighth connector after performing the connecting operation of the sixth connector, wherein the third controller and the fourth controller can be switched according to a necessary power source of the plurality of power sources.

18. The power supply according to claim 12, wherein the connector is constituted of a switching element for turning on/off a connection of the circuit.

19. The power supply according to claim 18, wherein the switch is constituted of an N-channel transistor, a P-channel transistor, or both of the N-channel transistor and the P-channel transistor.

20. The power supply according to claim 2, wherein each of the power sources is connected to a liquid crystal display device for displaying information by switching a voltage applied to liquid crystal and is supplied for the information display.
